(19) United States
(12) Patent Application Publication
(10) Pub. No.: US 2008/0138707 A1
(43) Pub. Date: Jun. 12, 2008

(54) Preparation of cathode active material by hydrothermal reaction

(76) Inventors: Esther S. Takeuchi, East Amherst, NY (US); Veronica Lamothe, Lancaster, NY (US); Randolph Leising, Williamsville, NY (US)

Correspondence Address: Greatbatch Ltd., 10,000 Wehrle Drive, Clarence, NY, 14031, US

(21) Appl. No.: 10/894,305

(22) Filed: Jul. 19, 2004

Related U.S. Application Data
(60) Provisional application No. 60/488,271, filed on Jul. 18, 2003.

(51) Int. Cl. H01M 4/54; C01G 31/02; C01G 5/00

(52) U.S. Cl. 429/219; 429/231.5; 423/594.8; 423/604

(57) ABSTRACT

The current invention relates to the preparation of an improved cathode active material for non-aqueous lithium electrochemical cell. In particular, the cathode active material comprised ε-phase silver vanadium oxide prepared by using silver- and vanadium-containing starting materials in a stoichiometric molar proportion to give a Ag:V ratio of about 1:2. The reactants are homogenized and then added to an aqueous solution followed by heating in a pressurized vessel. The resulting ε-phase SVO possesses a higher surface area than ε-phase SVO produced by other prior art techniques. Consequently, the ε-phase SVO material provides an advantage in greater discharge capacity in pulse dischargeable cells.

### CROSS-REFERENCE TO RELATED APPLICATION

This application claims priority from provisional application Ser. No. 60/488,271, filed Jul. 18, 2003.

### BACKGROUND OF THE INVENTION

1. Field of the Invention

This invention generally relates to the conversion of chemical energy to electrical energy. More particularly, the present invention relates to the preparation of an improved transition metal oxide cathode active material for non-aqueous lithium electrochemical cells prepared by a hydrothermal reaction. A most preferred cathode active material is ε-phase silver vanadium oxide (SVO, Ag₂V₄O₁₁). Silver vanadium oxide prepared by a hydrothermal synthesis is unlike ε-phase SVO prepared by prior art methods using solid-state thermal reactions or sol-gel techniques, and is particularly useful in an implantable electrochemical cell, for example of the type powering a cardiac defibrillator. In this type of application, the cell may run under a light load for significant periods interrupted from time to time by high rate pulse discharges, which ε-phase silver vanadium oxide is uniquely suited for.

2. Prior Art

Thermal synthesis of silver vanadium oxide can be accomplished by chemical decomposition, combination, or both decomposition and combination reactions. Synthesis of SVO by heating to induce a decomposition of the reactants is detailed in U.S. Pat. Nos. 4,310,609 and 4,391,729, both to Liang et al. This technique is further discussed in the publication: Leising, R. A.; Takeuchi, E. S. Chem. Mater. 1993, 5, 738-742. A typical example of a decomposition reaction resulting in the formation of SVO involves heat treatment of a mixture of AgNO₃ and V₂O₅ to a final temperature of from about 350° C. to about 520° C. The combination of Ag₂O and V₂O₅ heated to a maximum temperature of 520° C. to form SVO is described by Crespi in U.S. Pat. No. 5,221,453, and the synthesis of SVO at 500° C. via a dual decomposition/combination reaction is described in the publication: Leising, R. A.; Takeuchi, E. S. Chem. Mater. 1994, 6, 489-495. All of these SVO synthesis procedures share a high temperature thermal treatment step as a common process.

Silver vanadium oxide has also been synthesized via sol-gel methods. U.S. Pat. No. 5,558,680 to Takeuchi et al. describes the preparation of SVO utilizing sol-gel synthesis, with a final heating step of about 375° C. to about 450° C. Thus, although sol-gel technology is typically used for the preparation of materials at relatively low-temperatures, the synthesis of SVO by sol-gel techniques in the prior art has been limited to high temperature thermal treatments.

Hydrothermal synthesis has been used to prepare compounds other than SVO. For example, Myung, S.-T.; Komaba, S.; Kumagai, N. J. Electrochem. Soc. 149, A1349-A1357 (2002) describe the “Hydrothermal Synthesis of Orthorhombic LiCoₓMn₁₋ₓO₂ and Their Structural Changes During Cycling.” Furthermore, Nitta, Y.; Nagayama, M.; Miyahe, H.; Ohta, A. J. of Power Sources 81-82, 49-53 (1999) detail the “Synthesis and reaction mechanism of 3 V LiMnO₂”. While these disparate materials have been synthesized for use as battery cathode materials, the prior art hydrothermal reactions do not include transition metal oxides, such as SVO, as a contemplated cathode material. Furthermore, low temperature synthesis of SVO, regardless the preparation technique, has not been explored. Therefore, the preparation of transition metal oxides including SVO via hydrothermal synthesis at a relatively low temperature is a new discovery with unexpected results.

The above prior art patents and publications are incorporated herein by reference.

### SUMMARY OF THE INVENTION

The current invention relates to the preparation of an improved cathode active material for non-aqueous lithium electrochemical cells, and in particular, a cathode active material containing a transition metal oxide, preferably ε-phase SVO, prepared using a hydrothermal synthesis. For silver vanadium oxide, the hydrothermal reaction involves mixing a silver-containing material, such as a silver salt, with a vanadium-containing material in an aqueous solution heated at a relatively low temperature inside a pressure vessel. The preferred product ε-phase SVO possesses a higher surface area than ε-phase SVO produced by other synthesis techniques, such as by decomposition, addition or sol-gel reactions. The relatively high surface area of the product ε-phase SVO is a result of the low temperature used in the preparation of the material. For this reason, the ε-phase SVO exhibits greater long-term stability when used as a cathode active material in comparison to SVO with a lower specific surface area.

In addition, the high surface area SVO is a pure ε-phase material. By comparison, prior art thermal treatment and sol-gel synthesis techniques require high temperature steps to achieve phase pure SVO materials. However, the use of high temperature steps results in significant material sintering, resulting in a relatively low surface area product.

The present synthesis technique is not, however, limited to SVO. Salts of copper, magnesium and manganese can be used to produce alternate relatively high surface area transition metal oxide electrode active materials by hydrothermal synthesis as well.

These and other objects of the present invention will become increasingly more apparent to those skilled in the art by a reading of the following detailed description in conjunction with the appended drawings.

### BRIEF DESCRIPTION OF THE DRAWINGS

FIG. 1 is a SEM micrograph of SVO prepared by the hydrothermal synthesis described in Example II.

FIG. 2 is a SEM micrograph of SVO prepared by the prior art decomposition reaction described in Comparative Example III.

### DETAILED DESCRIPTION OF THE PREFERRED EMBODIMENTS

As used herein, the term “low temperature synthesis” means an aqueous solution containing two or more starting constituents heated to a maximum reaction temperature, no matter how many heating events there are, that is not greater than about 300° C.

The present invention describes a hydrothermal synthesis for preparing cathode materials for use in lithium electrochemical cells. In the hydrothermal synthesis of silver vanadium oxide having the general formula of AgₓV₂O_{y}, the silver- and vanadium-containing reactants are combined in stoichiometric molar proportions to give a Ag:V ratio of 1:2 for Ag₂ and V₂O₅ starting materials for the ε-phase (Ag₂V₄O₁₁). For the silver vanadate (AgVO₃) combined with V₂O₅, the molar proportion of Ag:V is 1:1. Hydrothermal synthesis is also useful for producing β-phase SVO having in the general formula x=0.33 and y=5 with a Ag:V molar ratio is about 0.16:1, and γ-phase SVO having x=0.74 and y=5.37 with the Ag:V molar ratio is about 0.4:1, or a mixture of the phases thereof.

Suitable silver-containing materials include elemental silver (Ag, Tₘ 962° C.), silver oxide (Ag₂O, Tₘ 230° C.), silver carbonate (Ag₂CO₃), Tₘ 210° C.), silver lactate (AgC₃H₅O₃, Tₘ 120° C.), silver triflate (AgCF₃SO₃, Tₘ 286° C.), silver pentafluoropropionate (AgC₃F₅O₂, Tₘ 242° C.), silver laurate (AgC₁₂H₂₃O₂, Tₘ 212° C.), silver myristate (AgC₁₄H₂₇O₂, Tₘ 211° C.) silver palmitate (AgC₁₆H₃₁O₂, Tₘ 209° C.), silver stearate (AgC₁₈H₃₅O₂, Tₘ 205° C.), silver vanadate (AgVO₃, Tₘ 465° C.), and mixtures thereof. Suitable vanadium-containing materials include NH₄VO₃, AgVO₃, VO, VO_{1.27}, VO₂, V₂O₄, V₂O₃, V₃O₅, V₄O₉, V₆O₁₃, V₂O₅, and mixtures thereof.

A typical hydrothermal reaction mechanism is illustrated in equation 1 for ε-phase silver vanadium oxide:

Ag₂O+2V₂O₅→Ag₂V₄O₁₁ (1)

Regardless the reactants, they are first ground, then added to an aqueous solution in a pressurized vessel and heated to a temperature of about 120° C. to about 300° C. for about 1 to 30 hours. Longer heating times are required for lower heating temperatures. The heating in the vessel is at a pressure range of about 14.7 psi to a maximum of about 1,800 psi. In that respect, the maximum heating temperature inside the pressure vessel can be either above or below the melting point of the reactive constituents. More important is that the heating takes place in an aqueous solution at a pressure above ambient.

When silver oxide (Ag₂O) and vanadium pentoxide (V₂O₅) are used in the synthesis, their homogeneous mixture in an aqueous solution contained inside a pressurized vessel is preferably heated to about 240° C. for at least about 12 hours. This temperature range is much lower than the typical solid-state thermal synthesis temperatures of about 500° C. to 1,000° C.

The following examples describe the manner and process of the present invention, and they set forth the best mode contemplated by the inventors of carrying out the invention, but they are not to be construed as limiting.

### Example I

Silver vanadium oxide was synthesized under hydrothermal conditions using Ag₂O and V₂O₅ in a molar ratio of 1:2. In particular, 0.116 grams of Ag₂O was added to 0.182 grams of V₂O₅ and the solids were ground together with a mortar and pestle to pass the entire mixture through a 230-mesh sieve. The solids were combined with 9 ml of distilled/de-ionized water and placed in a Model 4744 Acid Digestion Bomb (Parr Inst.). The sealed vessel was heated to about 240° C. over a period of about 2.5 hours, held at about 240° C. for about 12 hours, and then slowly cooled to room temperature over a period of about 8 hours. The SVO product was separated from the water solution, dried at about 120° C. for about 16 hours, and ground with a mortar and pestle.

### Example II

Silver vanadium oxide was synthesized under hydrothermal conditions using AgVO₃ and V₂O₅ in a molar ratio of 2:1. In particular, 0.414 grams of AgVO₃ was added to 0.182 grams of V₂O₅ and the solids were ground together with a mortar and pestle to pass the entire mixture through a 120-mesh sieve. The solids were combined with 9 ml of distilled/de-ionized water and placed in the Model 4744 Acid Digestion Bomb. The sealed vessel was heated to about 240° C. over a period of about 2.5 hours, held at about 240° C. for about 12 hours, and then slowly cooled to room temperature over a period of about 8 hours. The SVO product was separated from the water solution, dried at about 110° C. for about 16 hours under vacuum, and ground with a mortar and pestle.

### Comparative Example I

Silver vanadium oxide was synthesized by the prior art high temperature thermal treatment method using Ag₂O and V₂O₅ in a 1:2 molar ratio. In particular, 102.46 grams of Ag₂O was added to 160.84 grams of V₂O₅ and the solids were mixed together with a blender. The mixture was heated to about 500° C. in a furnace under an air atmosphere for about 50 hours of total heating time. During the high temperature-heating step, the sample was cooled to room temperature, ground with mortar and pestle and re-heated to about 500° C. The resulting material was used as synthesized.

### Comparative Example II

Silver vanadium oxide was synthesized by the prior art high temperature thermal treatment method using AgVO₃ and V₂O₅ in a 2:1 molar ratio. In particular, 182.89 grams of AgVO₃ was added to 80.43 grams of V₂O₅ and the solids were mixed together with a blender. The mixture was heated to about 500° C. in a furnace under an air atmosphere for about 50 hours of total heating time. During the high temperature heating step, the sample was cooled to room temperature, ground with mortar and pestle and re-heated to about 500° C. The resulting material was used as synthesized.

### Comparative Example III

Silver vanadium oxide was synthesized by the prior art high temperature thermal treatment method using AgNO₃ and V₂O₅ in a 1:1 molar ratio. In particular, 1.826 grams of AgNO₃ was added to 1.938 grams of V₂O₅ and the solids were ground together with a mortar and pestle to pass the entire mixture through a 120-mesh sieve. The mixture was added to a porcelain boat, and heated to about 300° C. in a tube furnace under flowing air for about 16 hours. The sample was cooled to room temperature, ground with mortar and pestle and heated to about 500° C. for about 16 hours. The resulting material was used as synthesized.

### Comparative Example IV

Silver vanadium oxide was synthesized via the prior art sol-gel method described in the previously discussed U.S. Pat. No. 5,558,680 to Takeuchi et al. using LiOH, AgNO₃ and V₂O₅, in a molar ratio of 0.05:0.95:2.0. In particular, 23.03 grams of V₂O₅ was mixed with 10.23 grams of AgNO₃ and 0.0075 grams of LiOH to give 33.33 grams of total solids. The mixture was added to 100 ml of distilled water to form a slurry that was about 25% solids and/or dissolved solids per solution weight. The slurry was heated to about 90° C. for about 3 hours with stirring. The sample was then cooled prior to dehydration and sintering at about 375° C. for about 24 hours under ambient atmosphere.

The XRD powder patterns collected for both the hydrothermal SVO and the prior art SVO materials demonstrate that the materials are all of a ε-phase (Ag₂V₄O₁₁). However, the hydrothermal synthesis of SVO described herein produces an active material that is different in surface area and morphology from that produced by the previously described prior art solid state thermal synthesis (Comparative Example I, II and III) and sol-gel technique (Comparative Example IV).

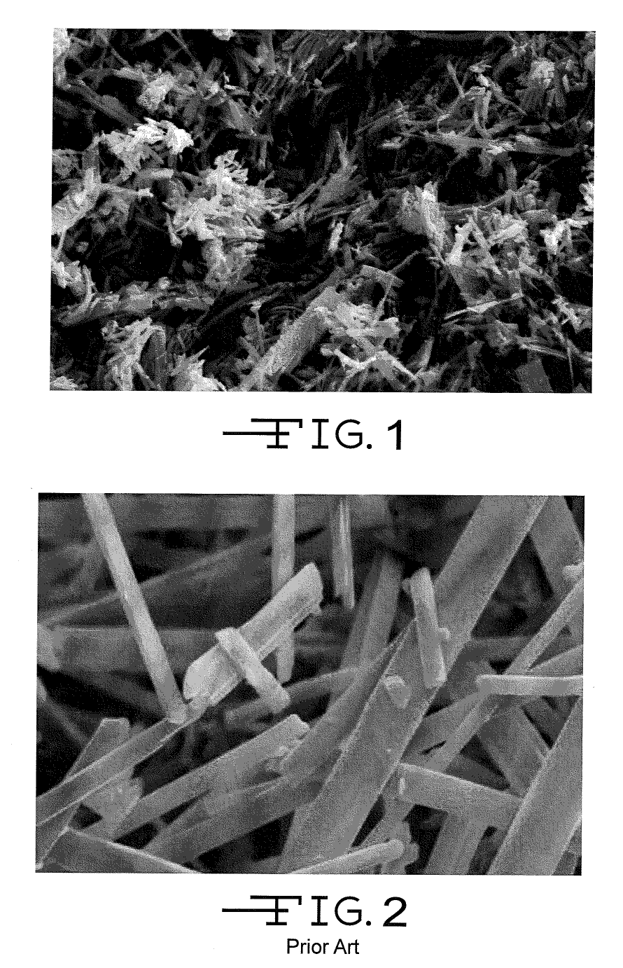

The SEM analysis of the competing products shows that the primary particle size of the hydrothermal SVO is significantly smaller than the primary particle size of the prior art SVO. This is illustrated in FIGS. 1 and 2. FIG. 1 is a SEM micrograph (magnification=10,000×, system vacuum=1.32e-006 Torr, EHT=10.00 kv, WD=6 mm and signal A+SE1) of SVO prepared under hydrothermal conditions according to Example II. FIG. 2 is a SEM micrograph (magnification=10,000×, system vacuum=7.58e-007 Torr, EHT=10.00 kv, WD=5 mm and signal A+SE1) of SVO prepared by the prior art thermal treatment method according to Comparative Example III.

In addition, the BET surface areas of the SVO materials are quite different, as illustrated in Table 1.

TABLE 1

| | Synthesis | Final | BET | |
|---|---|---|---|---|
| Example | Technique | Temperature | Surf. Area | |
| I | Hydrothermal | 240° C. | 26.9 | m²/g |
| II | Hydrothermal | 240° C. | 15.2 | m²/g |
| Comp. I | High Temp Thermal | 500° C. | 0.7 | m²/g |
| Comp. II | High Temp Thermal | 500° C. | 0.6 | m²/g |
| Comp. III | High Temp Thermal | 500° C. | 0.4 | m²/g |
| Comp. IV | Sol-Gel | 375° C. | 8.2 | m²/g |

The SVO synthesized by hydrothermal reactions yielded much higher BET surface areas, consistent with the small primary particle size of this material. The small particle size and high surface area of the hydrothermal SVO makes this unique material ideal for use as a cathode in high rate discharge applications.

Additionally, the SVO particles are of a nano particle size. For Example I, the primary particle diameter was measured as low as 27 nm in a 30,000×SEM image. For Example II, the primary particle diameter was measured as low as 33 nm in a 30,000×SEM image.

The above detailed description and examples are intended for the purpose of illustrating the invention, and are not to be construed as limiting. For example, the following compounds are reacted with any one of the above listed vanadium oxides as a homogeneous mixture in an aqueous solution contained inside a pressurized vessel heated to a temperature of about 120° C. to about 300° C. for about 1 to 30 hours to form alternate cathode active materials. For the production of copper silver vanadium oxide, CSVO, (Cu_{0.2}Ag_{0.8}V₂O_{5.6}), they are copper oxide (CuO, Tₘ 1,446° C.) or copper carbonate (Cu₂Co₃). The preferred molar proportion of Cu:Ag:V is in the range of 0.01:0.01:1 to 2:2:1.

For the production of copper vanadium oxide, CVO, (CuV₂O₆), they are copper oxide (CuO, Tₘ 1,446° C.) or copper carbonate (Cu₂Co₃). The preferred molar proportion of Cu:V is in the range of 0.01:1 to 2:1

For the production of manganese silver vanadium oxide, MnSVO, (Mn_{0.2}Ag_{0.8}V₂O_{5.8}), manganese carbonate (MnCO₃) or manganese oxide (MnO, Tₘ 1,650° C.) are used. The preferred molar proportion of MN:Ag:V is in the range of 0.01:0.01:1 to 2:2:1.

For the production of magnesium silver vanadium oxide, MgSVO, (Mg_{0.2}Ag_{0.8}V₂O_{5.6}), magnesium carbonate (MgCO₃, T_{d} 350° C.) or magnesium oxide (MgO, Tₘ 2,826° C.) are suitable. The preferred molar proportion of Mg:Ag:V is in the range of 0.01:0.01:1 to 2:2:1.

The use of the above mixed metal oxides as a cathode active material provides an electrochemical cell that possesses sufficient energy density and discharge capacity required for the vigorous requirements of implantable medical devices. These types of cells comprise an anode of a metal selected from Groups IA, IIA and IIIB of the Periodic Table of the Elements. Such anode active materials include lithium, sodium, potassium, etc., and their alloys and intermetallic compounds including, for example, Li—Mg, Li—Si, Li—Al, Li—B and Li—Si—B alloys and intermetallic compounds. The preferred anode comprises lithium. An alternate anode comprises a lithium alloy such as a lithium-aluminum alloy. The greater the amounts of aluminum present by weight in the alloy, however, the lower the energy density of the cell.

The form of the anode may vary, but preferably it is a thin metal sheet or foil of the anode metal, pressed or rolled on a metallic anode current collector, i.e., preferably comprising titanium, titanium alloy or nickel, to form an anode component. Copper, tungsten and tantalum are also suitable materials for the anode current collector. In the exemplary cell of the present invention, the anode current collector has an extended tab or lead, i.e., preferably of nickel or titanium, contacted by a weld to a cell case of conductive metal in a case-negative electrical configuration. Alternatively, the anode may be formed in some other geometry, such as a bobbin shape, cylinder or pellet to allow an alternate low surface cell design.

Before the previously described ε-phase SVO or alternate cathode active materials are fabrication into a cathode electrode for incorporation into an electrochemical cell, they are preferably mixed with a binder material, such as a powdered fluoro-polymer, more preferably powdered polytetrafluoroethylene (PTFE) or powdered polyvinylidene fluoride (PVDF), present at about 1 to about 5 weight percent of the cathode mixture. Further, up to about 10 weight percent of a conductive diluent is preferably added to the cathode mixture to improve conductivity. Suitable materials for this purpose include acetylene black, carbon black and/or graphite or a metallic powder such as of nickel, aluminum, titanium and stainless steel. The preferred cathode active mixture thus includes a powdered fluoro-polymer binder present at about 3 weight percent, a conductive diluent present at about 3 weight percent and about 94 weight percent of the cathode active material. For example, depending on the application of the electrochemical cell, the range of cathode compositions is from about 99% to about 80%, by weight, ε-phase silver vanadium oxide mixed with carbon graphite and PTFE.

Cathode components for incorporation into an electrochemical cell according to the present invention may be prepared by rolling, spreading or pressing the cathode active materials onto a suitable current collector selected from stainless steel, titanium, tantalum, platinum, gold, aluminum, cobalt-nickel alloys, nickel-containing alloys, highly alloyed ferritic stainless steel containing molybdenum and chromium, and nickel-, chromium- and molybdenum-containing alloys. Cathodes prepared as described above may be in the form of one or more plates operatively associated with at least one or more plates of anode material, or in the form of a strip wound with a corresponding strip of anode material in a structure similar to a “jellyroll”.

In order to prevent internal short circuit conditions, the cathode is separated from the Group IA, IIA or IIIB anode by a suitable separator material. The separator is of electrically insulative material, and the separator material also is chemically unreactive with the anode and cathode active materials and both chemically unreactive with and insoluble in the electrolyte. In addition, the separator material has a degree of porosity sufficient to allow flow there through of the electrolyte during the electrochemical reaction of the cell. Illustrative separator materials include fabrics woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, a polytetrafluoroethylene membrane commercially available under the designation ZITEX (Chemplast Inc.), a polypropylene membrane commercially available under the designation CELGARD (Celanese Plastic Company, Inc.) and a membrane commercially available under the designation DEXIGLAS (C.H. Dexter, Div., Dexter Corp.).

The electrochemical cell further includes a nonaqueous, ionically conductive electrolyte that serves as a medium for migration of ions between the anode and the cathode electrodes during the electrochemical reactions of the cell. The electrochemical reaction at the electrodes involves conversion of ions in atomic or molecular forms that migrate from the anode to the cathode. Thus, suitable nonaqueous electrolytes are substantially inert to the anode and cathode materials, and they comprise an inorganic, ionically conductive salt dissolved in a nonaqueous solvent. More preferably, the electrolyte includes an ionizable alkali metal salt dissolved in a mixture of aprotic organic solvents comprising a low viscosity solvent and a high permittivity solvent. The salt serves as the vehicle for migration of the anode ions to intercalate or react with the cathode active material. Preferably, the salt is lithium based including LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

Low viscosity solvents useful with the present invention include esters, linear and cyclic ethers and dialkyl carbonates such as tetrahydrofuran (THF), methyl acetate (MA), diglyme, trigylme, tetragylme, dimethyl carbonate (DMC), 1,2-dimethoxyethane (DME), 1,2-diethoxyethane (DEE), 1-ethoxy,2-methoxyethane (EME), ethyl methyl carbonate, methyl propyl carbonate, ethyl propyl carbonate, diethyl carbonate, dipropyl carbonate, and mixtures thereof. Suitable high permittivity solvents include cyclic carbonates, cyclic esters and cyclic amides such as propylene carbonate (PC), ethylene carbonate (EC), butylene carbonate (BC), acetonitrile, dimethyl sulfoxide, dimethyl formamide, dimethyl acetamide, γ-valerolactone, γ-butyrolactone (GBL), N-methyl-pyrrolidinone (NMP), and mixtures thereof. The preferred electrolyte for a Li/SVO cell is 0.8M to 1.5M LiAsF₆ or LiPF₆ dissolved in a 50:50 mixture, by volume, of propylene carbonate and 1,2-dimethoxyethane.

The preferred form of a primary alkali metal/solid cathode electrochemical cell is a case-negative design. This is where the anode is in contact with a conductive metal casing and the cathode contacted to a current collector is the positive terminal. The cathode current collector is in contact with a positive terminal pin via a lead welded to both the current collector and the positive terminal pin.

A preferred material for the casing is titanium although stainless steel, mild steel, nickel-plated mild steel and aluminum are also suitable. The casing header comprises a metallic lid having an opening to accommodate the glass-to-metal seal/terminal pin feedthrough for the cathode electrode. The anode electrode is preferably connected to the case or the lid. An additional opening is provided for electrolyte filling. The casing header is corrosion resistant and is compatible with the other components of the electrochemical cell. The cell is thereafter filled with the electrolyte solution described hereinabove and hermetically sealed such as by close-welding a titanium plug over the fill hole, but not limited thereto. The cell of the present invention can also be constructed in a case-positive design, as is well known by those skilled in the art.

It is appreciated that various modifications to the inventive concepts described herein may be apparent to those of ordinary skill in the art without departing from the spirit and scope of the present invention as defined by the appended claims.

1. An electrode active material comprising silver vanadium oxide characterized as prepared by mixing a silver-containing material and a vanadium-containing material in a solution contained in a closed vessel heated to a reaction temperature above ambient of not greater than about 300° C.

2. The electrode of claim 1 wherein the silver vanadium oxide has the formula Ag₂V₄O₁₁.

3. The electrode active material of claim 1 wherein the reaction temperature inside the closed vessel is from about 120° C. to about 300° C.

4. The electrode active material of claim 1 wherein the pressure in the closed vessel at the reaction temperature is about 14.7 psi to about 1,800 psi.

5. The electrode active material of claim 1 wherein the solution inside the closed vessel is characterized as having been heated at the reaction temperature for about 1 hour to about 30 hours.

6. The electrode active material of claim 1 wherein the silver- and vanadium-containing materials are in an aqueous solution in the closed vessel in a stoichiometric molar proportion to give a Ag:V ratio of about 1:2.

7. The electrode active material of claim 1 wherein the silver-containing material is selected from the group consisting of elemental silver, silver oxide, silver carbonate, silver lactate, silver triflate, silver pentafluoropropionate, silver laurate, silver myristate, silver palmitate, silver stearate, silver vanadate, and mixtures thereof, and wherein the vanadium-containing material is selected from the group consisting of NH₄VO₃, AgVO₃, VO, VO_{1.27}, VO₂, V₂O₄, V₂O₃, V₃O₅, V₄O₉, V₆O₁₃, V₂O₅, and mixtures thereof.

8. (canceled)

9. The electrode active material of claim 1 wherein the silver-containing material is AgVO₃ and the silver vanadium oxide has a BET surface area of about 15.2 m²/g.

10. A nonaqueous electrochemical cell, which comprises:
a) an anode comprising lithium;
b) a cathode comprising silver vanadium oxide characterized as having been prepared from a mixture of a silver-containing material and a vanadium-containing material in a solution contained in a closed vessel heated to a reaction temperature above ambient of not greater than about 300° C. to produce the silver vanadium oxide having the formula Ag₂V₄O₁₁;
c) a separator electrically isolating the anode from the cathode, and of a porosity to allow for ion flow there through; and
d) a non-aqueous electrolyte activating the anode and the cathode.

11. The electrochemical cell of claim 10 wherein the reaction temperature inside the closed vessel is about 120° C. to about 300° C.

12. The electrochemical cell of claim 10 wherein the pressure in the closed vessel at the reaction temperature is about 14.7 psi to about 1,800 psi.

13. The electrochemical cell of claim 10 wherein the solution inside the closed vessel is characterized as having been heated at the reaction temperature for about 1 hour to about 30 hours.

14. The electrochemical cell of claim 10 wherein the ε-phase silver vanadium oxide is characterized as having been cooled from the reaction temperature to ambient temperature in the closed vessel.

15. The electrochemical cell of claim 10 wherein the silver- and vanadium-containing materials are in a stoichiometric molar proportion in an aqueous solution in the closed vessel to give a Ag:V ratio of about 1:2.

16. The electrochemical cell of claim 10 wherein the silver-containing material is selected from the group consisting of elemental silver, silver oxide, silver carbonate, silver lactate, silver triflate, silver pentafluoropropionate, silver laurate, silver myristate, silver palmitate, silver stearate, silver vanadate, and mixtures thereof, and wherein the vanadium-containing material is selected from the group consisting of NH₄VO₃, AgVO₃, VO, VO_{1.27}, VO₂, V₂O₄, V₂O₃, V₃O₅, V₄O₉, V₆O₁₃, V₂O₅, and mixtures thereof.

17. A method for producing a cathode active material, comprising the steps of:
a) providing a silver-containing material;
b) providing a vanadium-containing material;
c) mixing the silver- and vanadium-containing materials together in an aqueous solution in a closed vessel; and
d) heating the solution to a reaction temperature of not greater than about 300° C. and a pressure above ambient up to about 1,800 psi to produce an ε-phase silver vanadium oxide having the formula Ag₂V₄O₁₁.

18. (canceled)

19. The method of claim 17 including heating the solution to the reaction temperature in a range from about 120° C. to about 300° C.

20. The method of claim 17 including heating the solution at the reaction temperature from about 1 hour to about 30 hours.

21. The method of claim 17 including cooling the ε-phase silver vanadium oxide from the reaction temperature to ambient temperature in the closed vessel.

22. The method of claim 17 including providing the silver- and vanadium-containing materials in a stoichiometric molar proportion in the solution in the closed vessel to give a Ag:V ratio of about 1:2.

23. The method of claim 17 including selecting the silver-containing material from the group consisting of elemental silver, silver oxide, silver carbonate, silver lactate, silver triflate, silver pentafluoropropionate, silver laurate, silver myristate, silver palmitate, silver stearate, silver vanadate, and mixtures thereof, and including selecting the vanadium-containing material from the group consisting of NH₄VO₃, AgVO₃, VO, VO_{1.27}, VO₂, V₂O₄, V₂O₃, V₃O₅, V₄O₉, V₆O₁₃, V₂O₅, and mixtures thereof.

24. The method of claim 17 wherein the silver-containing material is Ag₂O and the ε-phase silver vanadium oxide has a BET surface area of about 26.9 m²/g.

25. The method of claim 17 wherein the silver-containing material is AgVO₃ and the ε-phase silver vanadium oxide has a BET surface area of about 15.2 m²/g.

26. A method for producing a cathode active material, comprising the steps of:
a) providing a first metal-containing material;
b) providing a vanadium-containing material;
c) mixing the first metal- and vanadium-containing materials together in an aqueous solution in a closed vessel; and
d) heating the solution to a reaction temperature of not greater than about 300° C. and a pressure above ambient up to about 1,800 psi to produce a transition metal oxide.

27. (canceled)

28. The method of claim 26 including heating the aqueous solution to the reaction temperature in a range from about 120° C. to about 300° C.

29. The method of claim 26 including heating the aqueous solution at the reaction temperature from about 1 hour to about 30 hours.

30. The method of claim 26 including cooling the transition metal oxide from the reaction temperature to ambient temperature in the closed vessel.

31. The method of claim 26 including providing the first metal (FM)-containing material as a silver-containing material mixed with the vanadium-containing material in a stoichiometric molar proportion in the range of Ag:V of about 0.4:1.

32. The method of claim 26 including providing the first metal (FM)-containing material as a silver-containing material mixed with the vanadium-containing material in a stoichiometric molar proportion in the range of Ag:V of about 0.16:1.

33. The method of claim 26 including providing the first metal (FM)-containing material as a silver-containing material mixed with the vanadium-containing material in a stoichiometric molar proportion in the range of Ag:V of about 1:1.

34. The method of claim 26 including providing the first metal (FM)-containing material as a copper-containing material mixed with the vanadium-containing material in a stoichiometric molar proportion in the range of Cu:V of about 0.01:1 to about 2:1.

35. The method of claim 26 including providing the first metal (FM)-containing material as a copper-containing material and further providing a second metal (SM)-containing material as a silver-containing material mixed with the vanadium-containing material in a stoichiometric molar proportion in the range of Cu:Ag:V of about 0.01:0.01:1 to about 2:2:1.

36. The method of claim 26 including providing the first metal (FM)-containing material as a manganese-containing material and further providing a second metal (SM)-containing material as a silver-containing material mixed with the vanadium-containing material in a stoichiometric molar proportion in the range of Mn:Ag:V of about 0.01:0.01:1 to about 2:2:1.

37. The method of claim 26 including providing the first metal (FM)-containing material as a magnesium-containing material and further providing a second metal (SM)-containing material as a silver-containing material mixed with the vanadium-containing material in a stoichiometric molar proportion in the range of Mg:Ag:V of about 0.01:0.01:1 to about 2:2:1.

38. The method of claim 26 including selecting the vanadium-containing material from the group consisting of NH₄VO₃, AgVO₃, VO, VO_{1.27}, VO₂, V₂O₄, V₂O₃, V₃O₅, V₄O₉, V₆O₁₃, V₂O₅, and mixtures thereof.

39. The method of claim 26 wherein the first metal-containing material is selected from the group consisting of elemental silver, silver oxide, silver carbonate, silver lactate, silver triflate, silver pentafluoropropionate, silver laurate, silver myristate, silver palmitate, silver stearate, silver vanadate, and mixtures thereof, and the transition metal oxide is silver vanadium oxide.

40. The method of claim 26 wherein the first metal-containing material is either copper oxide or copper carbonate and the transition metal oxide is manganese silver vanadium oxide

41. The method of claim 26 wherein the first metal-containing material is either manganese oxide or manganese carbonate and the transition metal oxide is manganese silver vanadium oxide.

42. The method of claim 26 wherein the first metal-containing material is either magnesium oxide or magnesium carbonate and the transition metal oxide is magnesium silver vanadium oxide.

43. The method of claim 26 wherein the cathode active material is silver vanadium oxide having a primary particle diameter of about 27 nm to about 33 nm.
